(19) United States
(12) Patent Application Publication
(10) Pub. No.: US 2008/0170119 A1
(43) Pub. Date: Jul. 17, 2008

(54) Vision enhancement system

(76) Inventor: Jeffery McCann, (US)

Correspondence Address: TREX ENTERPRISES CORP., 10455 PACIFIC COURT, SAN DIEGO, CA, 92121, US

(21) Appl. No.: 11/652,798

(22) Filed: Jan. 12, 2007

(51) Int. Cl. H04N 7/18

(52) U.S. Cl. 348/113

(57) ABSTRACT

A vision enhancement system providing an enhanced image of the user's field of view. The enhanced image is projected in the user's line of sight using a CMOS camera to image the field of view, a small programmable image processor chip and a high resolution display. The invention provides a small, efficient, lightweight sensor that offers high resolution, wide field-of-view, and broad spectral coverage. In preferred embodiments the system is installed on aircraft pilot helmets to allow pilots enhanced visibility with minimal impact to normal operations.

The present invention relates to vision enhancement system and especially to helmet mounted vision enhancement systems.

### BACKGROUND OF THE INVENTION

Military and commercial pilots operate during periods of non-optimal lighting/visual conditions such as at night and bad weather. Pilot-friendly vision enhancement devices are needed to improve the pilot's ability to conduct flight operations with minimal impact. Various attempts have been made with varying degrees of success to provide a night vision system that has a wide field of view and does not impair normal head movement and sighting.

Modern digital imaging offers the ability to supplement real-time images with advanced processing techniques. New CMOS based imaging technology provides small, light weight, low-power cameras. Some of these cameras provide improved night vision capabilities along with digital processing to selectively enhance the images.

A need exists for pilots to enhance their vision in night and difficult weather with a user wearable (head mounted) optical system for operator enhanced vision is a continuing challenge.

### SUMMARY OF THE INVENTION

The present invention provides a vision enhancement system providing an enhanced image of the user's field of view. The enhanced image is projected in the user's line of sight using a CMOS camera to image the field of view, a small programmable image processor chip and a high resolution organic light emitting diode display. The invention provides a small, efficient, lightweight sensor that offers high resolution, wide field-of-view, and broad spectral coverage. In preferred embodiments the system is installed on aircraft pilot helmets to allow pilots enhanced visibility with minimal impact to normal operations.

### BRIEF DESCRIPTION OF THE DRAWINGS

FIG. 1 is a drawing of a preferred embodiment of the present invention.

FIG. 2 is a field of view presentation.

FIG. 3 shows an electrical block diagram for the FIG. 1 system.

FIG. 4 shows a prior art flip-up configuration.

FIG. 5 demonstrates some advantages of a special CMOS sensor array.

FIG. 6 compares quantum efficiency of microcrystalline germanium sensor with a generation III detector and with a moonless night light spectrum.

### DETAILED DESCRIPTION OF THE EMBODIMENT

### First Preferred Embodiment

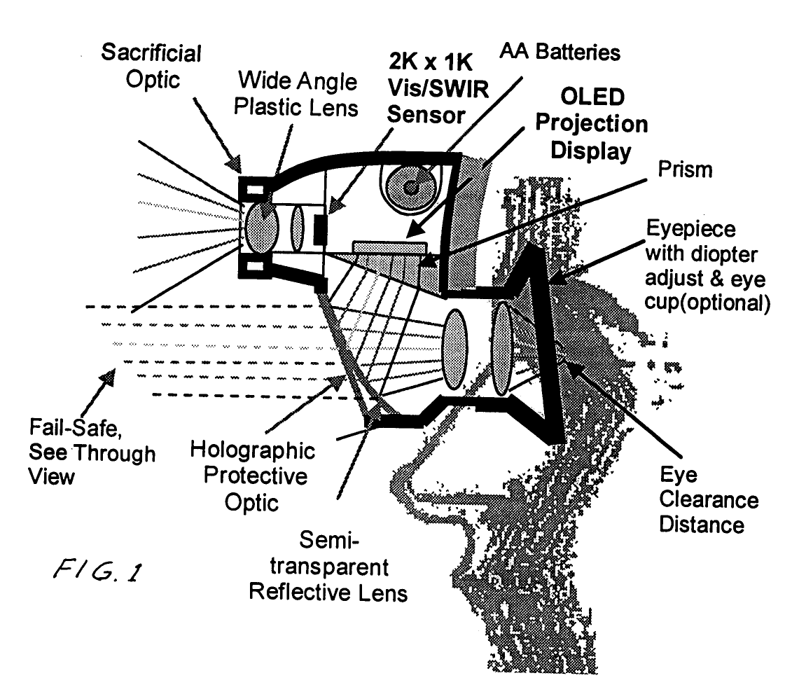

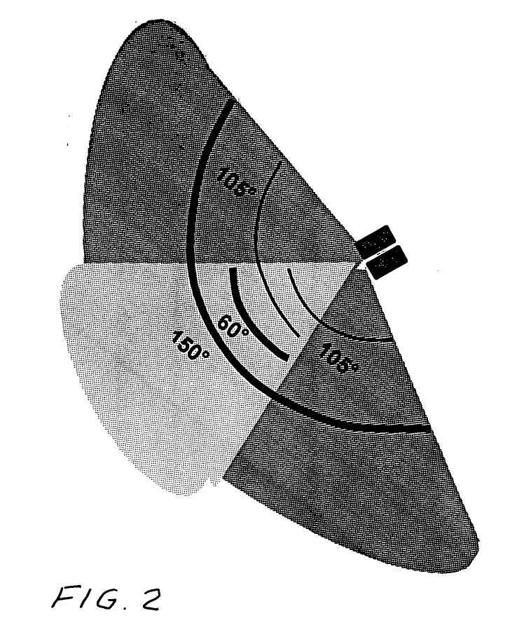

A preferred embodiment of the present invention can be described by reference to the figures. FIG. 1 shows a preferred embodiment adapted for use on an aircraft pilot helmet. The system is low in weight and power, is un-cooled, has a 150° by 59° field of view as shown in FIG. 2, is fully digital, and takes advantages of both the visible and short wave infrared spectrums for enhanced night vision capability. Special image processing is provided to adjust geometric viewing and incorporate important symbology.

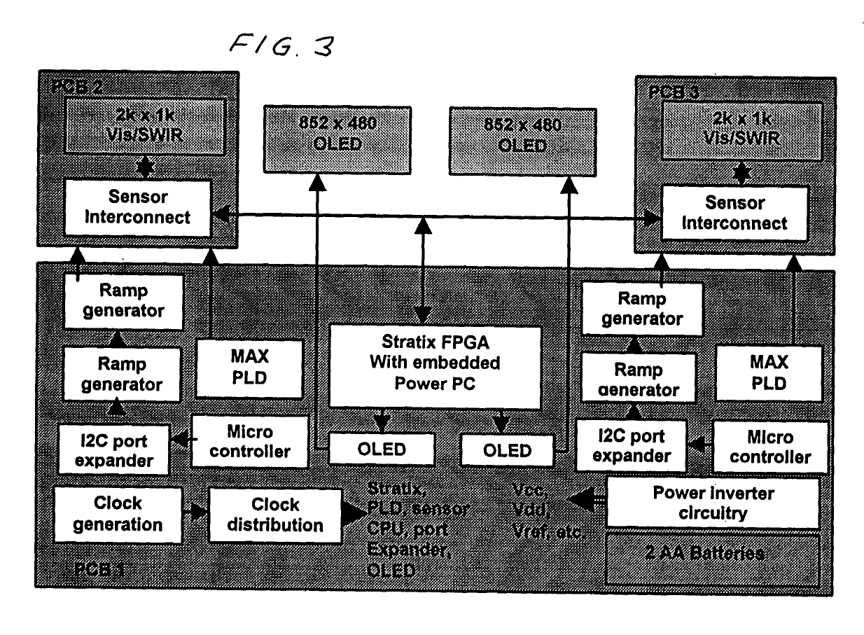

The system conforms to the pilot helmet and is built with a low-moment arm (i.e. the distance between the forehead and the center of mass of the system is less than 2 inches). The system utilizes a 1920×1080 sensor of the type described in U.S. Pat. No. 6,730,900 and U.S. patent application Publication No. 20060267054, both of which are incorporated herein by reference. The system operates at 30 frames per second and is capable of wavelength response in the visible to short wave infrared spectrum over the range of 350 nm to 1650 nm as indicated in FIG. 6. The optics are selected for the best combination of field of view (horizontal and vertical), resolution, and weight. After image acquisition, the raw data is sent to a small field programmable gate array for image processing improvements. In preferred embodiments all of the image processing is performed on-board the helmet; however, in other embodiments additional image processing could be accomplished off-board using a short range communication device. The acquired and processed image will be presented to the pilot by a low power organic light-emitting diode type device through a combination of reflective and refractive optics. Communications between each electronic component will follow industry standards to the extent possible. FIG. 3 shows a preferred electrical design.

### Focal Plane Arrays

A 2K×1K focal plane array shown at 10 in FIG. 1 has a 7.5 micron pixel pitch—this results in an active 17 mm diagonal focal plane. This provides the resolution of high definition television and the physically small focal plane enables a small, wide angle C-mount lens of approximately 0.75 inch diameter. This combination of short wave infrared sensitivity and wide angle lens results in the effective 66 line-pairs/millimeter resolution while providing field of view of about 105° through a single monocular channel.

The sensor enjoys the inherent power consumption advantages of CMOS sensors, while offering significant improvement in sensitivity. The typical power consumption of the 1920×1080 sensor is 0.2 watts for the sensor itself. The high pixel density of the sensor enables utilization of smaller, lightweight optics while maintaining a large field of view and high resolution. As an example, if optics were chosen such that the angular field of view of a 1920×1080 sensor is 100°×56° and the pilot operates at an altitude of 250 ft, then the field of view is 545 ft×257 ft (almost twice as large as a football field). The sensor resolution under these conditions is about 3 inches at 250 feet. The actual field of view and resolution will be defined based on pilot requirements. The resolution of the system will be better than current analog devices (generation IV image intensifiers) and since the focal plane array is multi-spectral, it has the potential to be used in a “color” mode.

### Fields of View

A full 150° field of view and stereoscopic capabilities is achieved by using two independent monocular channels that are integrated together—similar to standard binocular field glasses. A divergent overlap display that presents two separate images is designed as shown in FIG. 2. Each monocular device will contribute a 105° field of view with a 60° overlap in the middle. This central viewing region is where stereoscopic effects take place. The net result is 150° total field of view with the central 60° viewable in both eyes. The human process called binocular fusion combines those images to provide an apparent full 150° field of view with stereoscopic in the middle 60°.

Proper display to the human eye to create the 150° field of view is complex and requires the use of two organic light emitting diode displays, a specially designed semi-transparent reflector, and custom optics for the eyes. The design uses the embedded field programmable gate array to make geometric corrections to the display output for optimum viewing through the eyepiece.

There are situations when the system must operate in near or total darkness. The system is designed for a small 1550 nm expanded beam laser diode that can illuminate a 45° area out to about 30 yards. This 1550 nm laser is in the “eye safe” wavelengths and offers the ability for the operator to see while not being visible to the unaided eye.

### See Through Capability

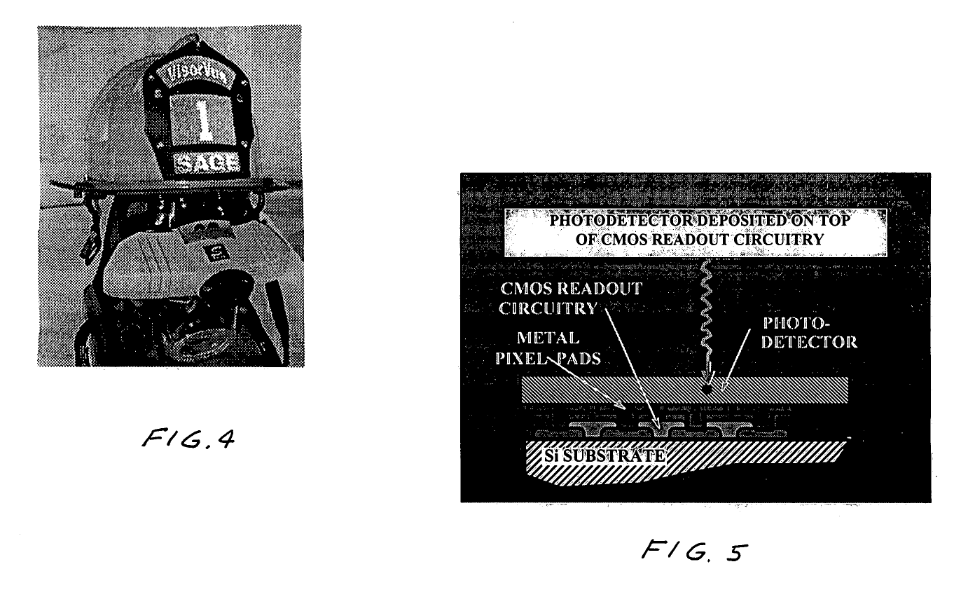

The system provides a “see through” capability with semi-transparent reflective lenses (when the display is off, the pilot can see through like a two-way mirror) and can revert to a fail safe mode where any device failure does not significantly impair the user's ability to operate. Also, in preferred embodiments the system could have a “flip up” connection to the helmet similar to prior art designs for Fire Fighters as shown in FIG. 4 that quickly takes the entire device out of view. The use of plastic lenses helps reduce weight. Plastic lenses are about four times lighter than their glass equivalents. The plastic does not have as broad a transmission spectrum as glass, but is good for the wavelengths of interest in visible and short wave infrared. Polycarbonates have excellent corrosion and wear properties, and will probably be used as a replaceable sacrificial lens immediately in front of the wide angle optics. The system has all solid state electrical components, and is designed with a high impact plastic housing and over-molded energy absorbing layer—this allows specifications for shock, impact, and acceleration and deceleration to be met in the final product. Controls on the system include: On/Off, Brightness, Diopter adjust, Mounting angle adjust, and Flip-up mode for quick access/clear field of vision.

The ability to reduce weight and power utilizing the CMOS sensor is a major design benefit. A 1-to1 ratio between the actual scene and displayed image is usually desired, but it could be possible to provide a lightweight zoom capability to about 4×. The focal plane array is about 8 mm×15 mm allowing C mount lenses (about 0.75″ diameter). In some preferred embodiments short range wireless communications can be provided within the cockpit using small commercially available technologies similar to ZigBee or Bluetooth. In such embodiments the wireless communication link should preferably include an additional compression chip to reduce the bandwidth enough for “Bluetooth” or “ZigBee” communications.

### CMOS Sensor Technology

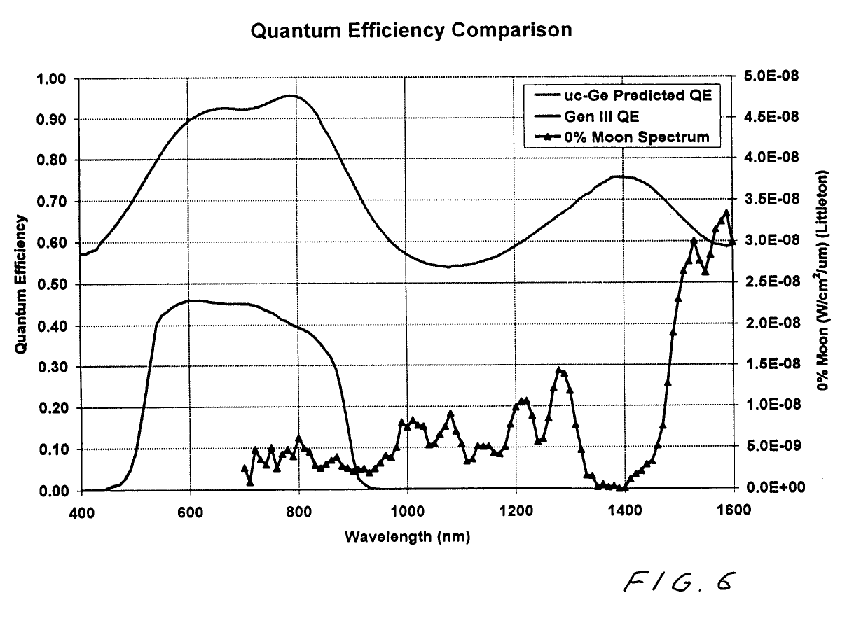

One of the key technologies for this embodiment of this invention is the use of an ultraviolet, visible, and short wave infrared sensitive CMOS focal plane array as described in the above referred to patent and patent application. This technology is built on years of fundamental work in advanced CMOS imaging research by Applicants and their fellow workers. This approach to CMOS image sensor technology improves the fill factor (active light collection area) of the sensor's pixel array to nearly 100%, while retaining the normal benefits of CMOS technology. In other (traditional) CMOS and CCD image sensor technologies, the light is absorbed by the crystalline silicon substrate of the device itself. The problem with this traditional approach is that light must pass through the metal and polysilicon lines that are patterned on the surface of the device before it is absorbed in the silicon below. As can be imagined, much of the light does not make it through the metal and polysilicon interconnection circuitry and is lost—the fill factor is lowered (to a net ˜30% fill factor). With the present approach, a thin, highly absorbing layer is coated conformally onto the surface of the device, and this layer serves as the light collection region as indicated in FIG. 5. The whole surface of the device is used for light collection, and the whole area below this thin-film surface can be used for circuitry. Back-thinned CCD technology can also come close to achieving a 100% fill factor, but that technique is very costly when compared to the thin film coating used in a CMOS sensor. The CMOS sensor technology exhibits other good performance characteristics, some of which derive from the surface coating, and some of which derive from the use of CMOS read-out circuitry. Some of these other advantages are:
Complete independence of photodetector and circuit design
High Fill Factor (˜100%)
High Quantum Efficiency (>80% peak)
High Radiation Tolerance
Low Power (˜100 mw/Mpixel)
High Integration (on-chip control and A/D conversion)
High Frame Rate (from 30 Hz to 1000 Hz)
UV and IR wavelength extendibility with minimal photodetector modifications

The photo-detector is grown on the surface of the read-out integrated circuit; there is no loss of fill factor due to the space taken up by the unit cell electronics. The pixel pitch can therefore be scaled down to as small as the CMOS design rules allow with no incurred response losses in the coating. Another advantage of this technology is that since the photo-detector is grown on the surface over the pixel circuits in a separate step, the photo-detector has great flexibility in its composition. This allows for the independent optimization for ultraviolet, visible, and shortwave infrared response as well as the photo-detector response time.

For preferred embodiments of this invention, the CMOS sensor uses a microcrystalline germanium (μc-Ge) coating that provides spectral sensitivity from about 290 nm to about 1675 nm. As shown in FIG. 6, this spectral sensitivity covers a large portion of the visible and shortwave infrared spectrum and illustrates the significant fraction of available photons that are not collected using generation III technology. A μc-Ge sensor, however, can collect and process a much larger portion of the available night sky. The μc-Ge coating is applied to existing 1920×1080 pixel arrays to provide low power (less than 200 mW per focal plane array) imaging devices that have broad multi-spectral sensitivity. For example, there is over 20 times more irradiance in the 900 to 1700 regime than in the visible regime during moonless night conditions.

### Image Processing

The design includes two small 1.0÷×1.5″ sensor boards and one 1.2″×4.0″ processing board. Net power consumption of the system that includes the 2 focal plane arrays, 2 displays, and a single field programmable gate array (that can process either a single channel in a monocular version or two channels in the binocular version) should be less than 2 Watts.

Because the data is digital, simple processing on the processor will convert between the focal plane array and the display driver. This processing step allows other algorithms of interest to be introduced such as automatic gain control, pseudo color look up table, and geometric corrections. The gain control extends the dynamic range considerably so that full sensitivity can be applied to dark regions without being washed out by bright events. It also allows instantaneous response (i.e. within a single 16 ms frame) to changing lighting (e.g. spotlights) so that the operator does not lose imagery due to system blooming. Pseudo colors and geometric corrections allow the digital image to be manipulated for best viewing. These processing algorithms come with no weight or power cost once the basic processing chip is integrated. The components proposed are largely off-the-shelf with standards (e.g. HDTV 1080P) that will allow modifications and improvements to occur readily in the future. The reliance on off-the-shelf components also allows for a cost structure that should allow for units to be sold for under $10,000 in limited production quantities.

### Advantages

Advantages of the preferred embodiment include:
Enhanced vision configuration in which the visible is augmented with addition of important non-visible spectral bands and detection processing; and
A Night Vision configuration, where high resolution and sensitivity are obtained in the SWIR, while simultaneously adding processed imagery; or
An electronic focusing configuration in which specific portion of the image is enhanced. Also, the “fusing” of image data in different spectral bands is greatly expedited if a single focal-plane array can be used.

The greater number of spectral bands a single sensor can accommodate the more mission configurations are available. It is also useful to meet the high definition television progressive scan 1920×1080 standards, which offer an important design point since many commercial-off-the-shelf components will be built to meet that specification. An HDTV 1080P camera with 60 fps also offers a field of view that is over twice that offered by the generation IV night vision sensors. There are other potential uses in the areas of surveillance and force protection for a camera with wide spectral response.

While there have been shown what are presently considered to be preferred embodiments of the present invention, it will be apparent to those skilled in the art that various changes and modifications can be made herein without departing from the scope and spirit of the invention. For example, the binocular system could be adapted for use on only one eye or alternate techniques could be applied to mount the system as goggles instead of the helmet mount. The laser light source could be replaced with other light sources. The system could be useful in a wide range of situation other than for pilots of airplanes. It could be applied for drivers of motor vehicles especially for people who do not see well in the dark. Thus, the scope of the invention is to be determined by the appended claims and their legal equivalents.

We claim:

1. A helmet mounted binocular vision enhancement system providing an enhanced images of fields of view of a user' two eyes, said system comprising:
A) two CMOS cameras, each camera comprising:
1) a wide angle lens to image a field of view corresponding at least in part to the fields of view of one of the user's two eyes,
2) a CMOS focal plane array sensor,
B) two high-resolution displays and
C) two image processor chips programmed to process image information collected by said CMOS sensors and to control said displays to provide images corresponding to fields of view of the two eyes of the user;
wherein said cameras and displays are mounted on a helmet worn by said user with the displays positioned in the user's line of sight of each of his two eyes.

2. The system as in claim 1 wherein said sensor is a microcrystalline germanium CMOS sensor.

3. The system as in claim 1 wherein said sensor having about 2,000 times 1,000 pixels.

4. The system as in claim 1 wherein said sensor is comprised of a photo-diode layer covering sensor pixel circuits.

5. The system as in claim 1 wherein the image processor chips are programmable gate arrays

6. The system as in claim 1 wherein fields of view of each of the two cameras is about 105 degrees.

7. The system as in claim 6 wherein the fields of view of each of the two cameras overlap about 60 degrees.

8. The system as in claim 1 wherein a flip-up option is available to take the system out of the user's line of sight.

9. The system as in claim 1 and further comprising a light source for illuminating at least a portion of the fields of view of the two cameras.

10. The system as in claim 9 wherein the light source is a laser light source.

11. The system as in claim 10 wherein said laser light source is at a wavelength outside the visible spectrum.

12. A binocular vision enhancement system providing an enhanced images of fields of view of a user' two eyes, said system comprising:
A) two CMOS cameras, each camera comprising:
1) a wide angle lens to image a field of view corresponding at least in part to the fields of view of one of the user's two eyes,
2) a CMOS focal plane array sensor,
B) two high-resolution displays and
C) two image processor chips programmed to process image information collected by said CMOS sensors and to control said displays to provide images corresponding to fields of view of the two eyes of the user;
wherein said cameras and displays are mounted on a helmet worn by said user with the displays positioned in the user's line of sight of each of his two eyes.

13. A vision enhancement system providing enhanced images of field of view, said system comprising:
A) a CMOS cameras comprising:
1) a lens to image a field of view corresponding at least in part to the fields of view of one of the user's two eyes,
2) a CMOS focal plane array sensor,
B) a high-resolution display, and
C) an image processor circuit programmed to process image information collected by said CMOS sensor and to control said display to provide images corresponding to field of view.

14. The system as in claim 13 wherein said sensor is a microcrystalline germanium CMOS sensor.

15. The system as in claim 13 wherein said sensor having about 2,000 times 1,000 pixels.

16. The system as in claim 13 wherein said sensor is comprised of a photo-diode layer covering sensor pixel circuits.

17. The system as in claim 13 wherein the image processor chips are programmable gate arrays

18. The system as in claim 13 wherein field of view of the camera is about 105 degrees.

19. The system as in claim 13 wherein the lens is an adjustable zoom lens.

20. The system as in claim 13 and further comprising a light source for illuminating at least a portion of the fields of view of the camera.
